(19) United States
(12) Patent Application Publication
(10) Pub. No.: US 2012/0073931 A1
(43) Pub. Date: Mar. 29, 2012

(54) CLUTCH APPARATUS FOR AUTOMATIC TRANSMISSION

(75) Inventor: Seongeun Yun, Hwaseong-si (KR)

(73) Assignee: Hyundai Motor Company, Seoul (KR)

(21) Appl. No.: 12/945,647

(22) Filed: Nov. 12, 2010

(30) Foreign Application Priority Data
Sep. 29, 2010 (KR) 10-2010-0094802

(51) Int. Cl. F16D 25/0638; F16D 25/12

(52) U.S. Cl. 192/109 R

(57) ABSTRACT

A clutch apparatus for an automatic transmission makes it possible to reduce the number of parts, the weight, and manufacturing costs. Centrifugal hydraulic pressure due to operation oil is not generated in an operational hydraulic chamber when a clutch does not operate, that is, the operation oil is not supplied to operational hydraulic chamber, such that malfunction in which a clutch piston moves to a spring seat does not occur, and a balance hydraulic chamber and balance piston are not required. The clutch apparatus for an automatic transmission may include an operational hydraulic pressure supply hole formed at a boss portion of a retainer to be connected with an operational hydraulic chamber formed between the retainer and a clutch piston; and a sealing member disposed in a sealing groove formed in the clutch piston, making a gap between the retainer and the sealing member when a clutch does not operate, that is, operation oil is not supplied to the operational hydraulic chamber, and making the sealing groove and retainer in close contact when the clutch operates, that is, the operation oil is supplied to the operational hydraulic chamber such that the operational hydraulic chamber is kept hermetically sealed.

### CROSS-REFERENCE TO RELATED APPLICATIONS

The present application claims priority to Korean Patent Application Number 10-2010-0094802 filed Sep. 29, 2010, the entire contents of which application is incorporated herein for all purposes by this reference.

### BACKGROUND OF THE INVENTION

1. Field of the Invention

The present invention relates to a clutch apparatus for an automatic transmission, and more particularly, to a clutch apparatus for an automatic transmission that can prevent malfunction of a clutch piston by preventing centrifugal hydraulic pressure in an operational hydraulic chamber when the clutch does not operate.

2. Description of Related Art

In general, automatic transmissions are devices automatically outputting several steps of gear ratios in accordance with the open amount of a throttle with respect to the vehicle speed in traveling, and includes a planetary gear set implementing several shift steps, a clutch and a friction element of a brake system which transmit power or restrict operation by selectively the friction element with the input shaft or the case of the transmission such that the elements of the planetary gear set function as input, output, and reacting elements, respectively, and a hydraulic pressure control system supplying operational pressure for the operation of the friction element.

Meanwhile, in friction elements of automatic transmissions of the related art, a clutch includes, as shown in FIG. 1, a retainer 3 connected to an input shaft 1 disposed at the center in a case (not shown) in a slip-connection type, a plurality of plates 5 of which the outer circumferences are fitted on the inner circumference of retainer 3 in a slip-connection type, and a plurality of discs 9 disposed between plates 5 and having the inner circumferences fitted on the outer circumference, in a slip-connection type, of a hub 7 connected with a corresponding element of the planetary gear set.

Retainer 3 is provided with a clutch piston 11 pressing plates 5, using pressure of operation oil, and for this configuration, an operational hydraulic chamber 14 is formed in a space between retainer 3 and clutch piston 11 and an operational hydraulic pressure supply hole 15 connected with operational hydraulic chamber 13 is formed boss portion 43a of retainer 3.

Further, a balance piston 19 is disposed such that a balance hydraulic chamber 17 is formed opposite to operational hydraulic chamber 13 with clutch piston 11 therebetween, a return spring 21 of which both ends are supported by clutch piston 11 and balance piston 19 is disposed to provide elastic return force for the operation of clutch piston 11, and a balance hydraulic pressure supply hole 23 connected with balance hydraulic chamber 17 is formed at boss portion 3a of retainer 3.

In the clutch apparatus having the above configuration, as hydraulic pressure supplied to operational hydraulic chamber 13 through operational hydraulic pressure supply hole 15 by the operation of the hydraulic control system, clutch piston 11 moves to balance piston 19 against the force of return spring 21 and clutch piston 11 correspondingly presses plates 5 such that plates 5 and discs 9 can transmit power by frictional contact. Therefore, power inputted to input shaft 1 is transmitted to corresponding elements of the planetary gear set connected to hub 7, through retainer 3, plates 5, discs 9, and hubs 7.

Further, when hydraulic pressure is discharged from operational hydraulic chamber 13, clutch piston 11 returns to the initial position by means of return force of return spring 21 while plates 5 and discs 9 are separated, such that torque is not transmitted to hub 7 even if input shaft 10 rotates.

Meanwhile, operational hydraulic chamber 13 should have a hermetic structure so that clutch piston 11 moves to balance piston 19 by means of the pressure of the operation oil supplied to operational hydraulic chamber 13 in the operation of the clutch, which is implemented by a sealing member 25 that is fixed to clutch piston 11, with the front end in contact with retainer 3, and keep airtightness between clutch piston 11 and retainer 3.

However, since sealing member 25 is always in contact with retainer 3, even though operation oil is not supplied to operational hydraulic chamber 13 in the clutch apparatus of the related art, clutch piston 11 is moved to balance piston 19 by centrifugal hydraulic pressure of the operation oil remaining in operational hydraulic chamber 13 when it does not operate, such that malfunction that makes plates 5 and discs 9 in friction contact frequently occurs.

That is, in a non-operation state, that is, when the operation oil is not supplied to operational hydraulic chamber 13, clutch piston 11 should not move to balance piston 19, and plates 5 and discs 9 should not be in contact, and accordingly, the operation oil supplied to operational hydraulic chamber 13 in shifting should be completely discharged from operational hydraulic chamber 13 in the non-shifting.

However, in the non-operation state, some of the operation oil remains in operational hydraulic chamber 13 by sealing member 25, such that clutch piston 11 is moves to balance piston 19 by centrifugal hydraulic pressure of the operation oil remaining in operational hydraulic chamber 13 in the non-operation state, and accordingly, malfunction that plates 5 and discs 9 are in contact occurs.

The information disclosed in this Background section is only for enhancement of understanding of the general background of the invention and should not be taken as an acknowledgement or any form of suggestion that this information forms the prior art already known to a person skilled in the art.

### BRIEF SUMMARY OF THE INVENTION

The present invention has been made in an effort to provide a clutch apparatus for an automatic transmission that prevents centrifugal hydraulic pressure in an operational hydraulic chamber by completely removing operation oil from the operational hydraulic chamber when the clutch does not operate, and prevents malfunction of a clutch piston that makes plates and discs in contact.

Further, the present invention has been made in an effort to provide a clutch apparatus for an automatic transmission having advantages of reducing weight and manufacturing cost by removing a balance piston from a clutch apparatus.

Various aspects of the present invention provide for a clutch apparatus for an automatic transmission, which includes an operational hydraulic pressure supply hole formed at a boss portion of a retainer to be connected with an operational hydraulic chamber formed between the retainer and a clutch piston, and a sealing member disposed in a sealing groove formed in the clutch piston, making a gap between the retainer and the sealing member when a clutch does not operate, that is, operation oil is not supplied to the operational hydraulic chamber, and making the sealing groove and retainer in close contact when the clutch operates, that is, the operation oil is supplied to the operational hydraulic chamber such that the operational hydraulic chamber is kept hermetic.

Further, the clutch apparatus for an automatic transmission further includes a spring seat fixed to a boss portion of the retainer to be opposite to the retainer, with the clutch piston therebetween, and a return spring having both ends supported by the clutch piston and the spring seat and providing force for pressing the clutch piston to the retainer.

In this configuration, according to various aspects of the present invention, the sealing groove has a cross-section open to the retainer and has an inner side opposite to the retainer and both sides connected with the inner side, in which one side in both sides which is connected with the operational hydraulic pressure supply hole is a vertical surface perpendicular to the inner side, and the other side opposite to the vertical surface is an inclined surface making an obtuse angle with the inner side, and the surfaces respectively opposite to the vertical surface and the inclined surface of the sealing groove, in the sealing member disposed in the sealing groove, are a vertical surface and an inclined surface which have the same shapes.

Further according to other aspects of the present invention, the sealing groove has a cross-section open to the retainer and has an inner side opposite to the retainer and both sides connected with the inner side, and both sides are vertical surfaces which are perpendicular to the inner side, and one side opposite to the operational hydraulic pressure supply hole in the sealing member disposed in the sealing groove is an inclined surface gradually decreasing in width toward the outer circumference from the inner circumference of the sealing member, and the other side opposite to the inclined surface is a vertical surface having the same shape as the vertical surface of the sealing groove.

According to various aspects of the present invention, it is possible to improve reliability and performance of a product, because centrifugal hydraulic pressure due to operation oil is not generated in the operational hydraulic chamber when the clutch does not operate, that is, the operation oil is not supplied to the operational hydraulic chamber, such that malfunction in which the clutch piston moves to the spring seat does not occur.

Further, according to various aspects of the present invention, it is possible to reduce the number of parts, the weight, and the manufacturing cost, because a balance hydraulic chamber and balance piston are not required.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view of a clutch apparatus for an automatic transmission of the related art.

FIG. 2 is a view of a clutch apparatus for an exemplary automatic transmission according to the present invention.

FIG. 3 is an enlarged view of a sealing groove and a sealing member shown in FIG. 2.

FIG. 4 is a view showing an exemplary operation of the sealing member when the clutch operates.

FIG. 5 is a view of an exemplary sealing member having a circular protrusion.

FIGS. 6 and 7 are views showing an exemplary sealing groove and an exemplary sealing member according to the present invention.

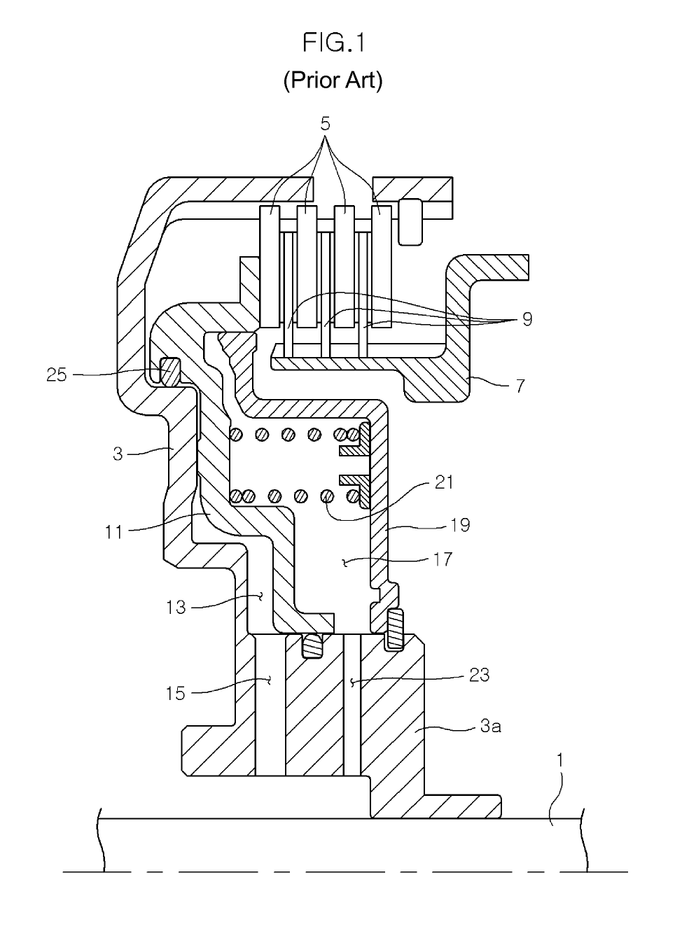

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

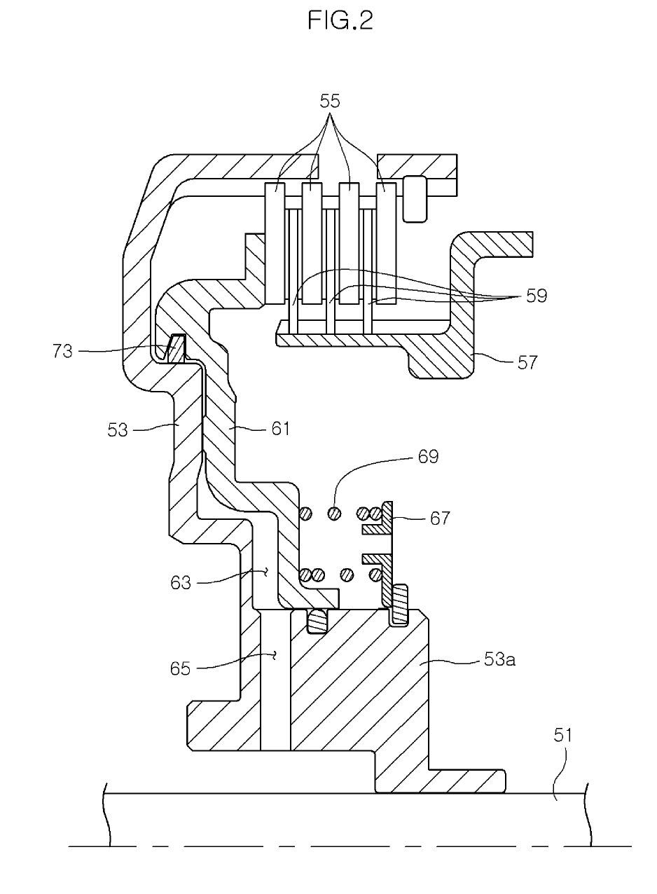

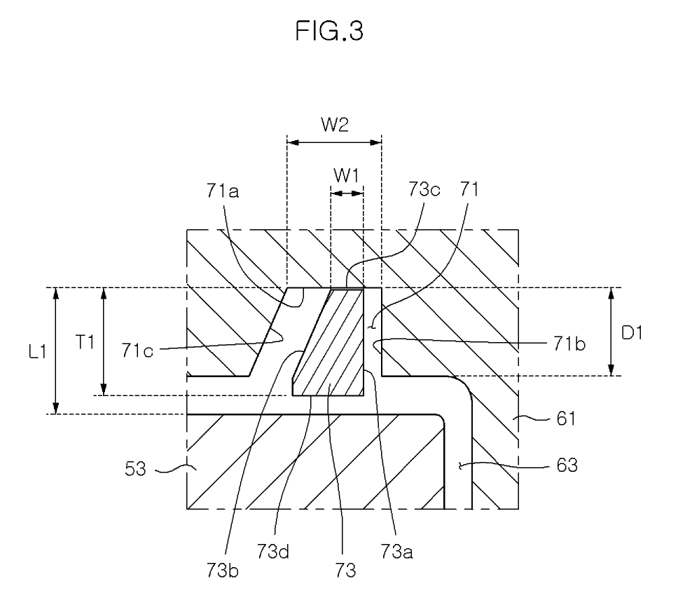

A clutch apparatus for an automatic transmission, as shown in FIGS. 2 and 3, includes a retainer 53 connected to an input shaft 51 disposed at the center in a case (not shown) in a slip-connection type, a plurality of plates 55 of which the outer circumferences are fitted on the inner circumference of retainer 53 in a slip-connection type, and a plurality of discs 59 disposed between plates 55 and having the inner circumferences fitted on the outer circumference, in a slip-connection type, of a hub 57 connected with a corresponding element of the planetary gear set.

In this configuration, retainer 53 is provided with a clutch piston 61 pressing plates 55, using pressure of operation oil, and for this configuration, an operational hydraulic chamber 63 is formed in a space between retainer 53 and clutch piston 61 and an operational hydraulic pressure supply hole 65 connected with operational hydraulic chamber 63 is formed in boss portion 53a of retainer 53.

Further, a spring seat 67 is fixed to boss portion 53a of retainer 53, opposite to retainer 53 with clutch piston 61 therebetween, and a return spring 69 of which both ends are supported and fixed to clutch piston 61 and spring seat 67 is disposed to provide force pressing clutch piston 61 to retainer 53.

Further, according to various embodiments of the present invention, a sealing groove 71 is formed in clutch piston 61 and a sealing member 73 is formed in seating groove 71, such that a gap C1 is formed between sealing member 73 and retainer 53 when the clutch does not operate, that I, operation oil is not supplied to operational hydraulic chamber 63, whereas sealing groove 71 and retainer 53 are in contact to keep operational hydraulic chamber 63 hermetic, when clutch operate, that is, the operation oil is supplied to operational hydraulic chamber 63.

Sealing groove 71 has a cross-section open to retainer 53 and has an inner side 71a opposite to retainer 53 and both sides connected with inner side 71a, where one side in both sides which is connected with operational hydraulic pressure supply hole 63 is a vertical surface 71b perpendicular to inner side 71a and the other side opposite to vertical surface 71b is an inclined surface 71c making an obtuse angle with inner side 71a.

Further, the surfaces respectively opposite to vertical surface 71b and inclined surface 71c of sealing groove 71, in sealing member 73 disposed in sealing groove 71, are a vertical surface 73a and an inclined surface 73b which have the same shapes.

Further, with sealing member 73 disposed in sealing groove 71, the thickness T1 of sealing member 73 is larger than the depth D1 of sealing groove 71 and smaller than the gap L1 between inner side 71a of sealing groove 71 and retainer 53 while the width W1 of the outer circumference 73c of sealing member 73 is smaller than the width W2 of inner side 71a of sealing groove 71.

The operation of the clutch apparatus of the present invention is described hereafter.

First, when the clutch does not operate, that is, the operation oil is not supplied to operational hydraulic chamber 63, sealing member 73 is positioned with outer circumference 73c in close contact with inner side 71a of sealing groove 71 by its elastic force and centrifugal force, as shown in FIG. 3, such that gap C1 is defined between the inner circumference 73d of sealing member 73 and retainer 53.

Therefore, the operation oil remaining in operational hydraulic chamber 63 is completely discharged out of operational hydraulic chamber 63 through gap C1, such that centrifugal hydraulic pressure due to the operation oil is not generated in operational hydraulic chamber 63.

Further, since centrifugal hydraulic pressure due to is not generated, clutch piston 61 does not move to spring seat 67 against the force of return spring 69, and as a result, malfunction that make plates 55 and discs 59 in contact, thereby improving reliability and performance of the product.

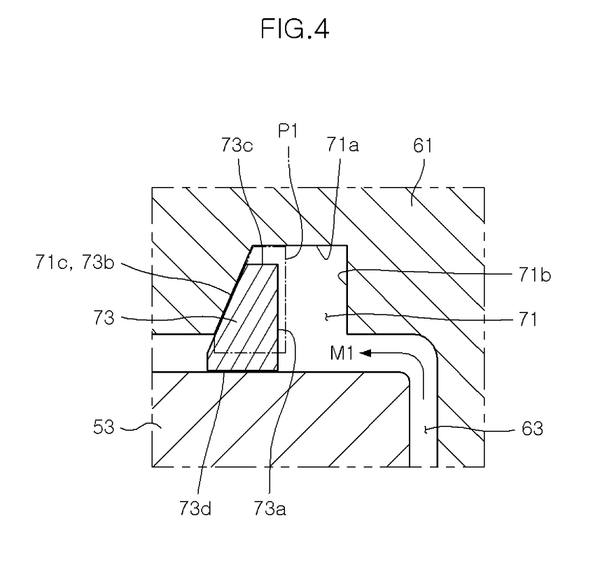

Further, as hydraulic pressure is supplied to operational hydraulic chamber 63 through operational hydraulic pressure supply hole 65 by the operation of the hydraulic pressure control system in order to operate the clutch, as indicated by an arrow M1 in FIG. 4, the hydraulic pressure of the operation oil is applied to vertical surface 73a of sealing member 73, such that sealing member 73 moves with outer circumference 73c in contact with inner side 71a of sealing groove 71 and inclined surface 73b of sealing member 73 and inclined surface 71c of sealing groove 71 come in contact (the state P1 indicated by a dotted line in FIG. 4).

Sealing member 73 moves down along inclined surface 71c of sealing groove 71 such that inner circumference 73d comes in contact with retainer 53 by the pressure of the operation oil which is continuously applied in the above state, such that operational hydraulic pressure supply hole 65 is kept hermetic to be completely sealed by sealing member 73 that is in closed contact with inclined surface 71c of sealing groove 71 and retainer 53.

Accordingly, clutch piston 61 is moved to spring seat 67 against the force of return spring 69 by the hydraulic pressure of the operation oil supplied to operational hydraulic pressure supply hole 65 and applied to clutch piston 61, and accordingly, clutch piston 61 presses plates 55 such that plates 55 and discs 59 can transmit power by friction contact, such that the power inputted to input shaft 57 is transmitted to corresponding elements of the planetary gear set connected with hub 57 through retainer 53, plates 55, discs 59, and hub 57.

The clutch apparatus having the above configuration according to various embodiments of the present invention has the advantage of improving reliability and performance of the product, because when the clutch does not operate, that is, the operation oil is not supplied to operational hydraulic chamber 63, operational hydraulic chamber 63 is kept open and the operation oil remaining in operational hydraulic chamber 63 is completely discharged out of operational hydraulic chamber 63, such that centrifugal hydraulic pressure due to the operation oil is not generated in operational hydraulic chamber 63 and a malfunction in which clutch piston 61 moves to spring seat 67 does not occur.

Further, since the centrifugal hydraulic pressure is not generated in operational hydraulic chamber 63 when the clutch does not operate, the clutch apparatus of the present invention does not need a balance hydraulic chamber, which is used in the related art, such that a balance piston is also not required, thereby reducing the number of parts, the weight, and the manufacturing cost.

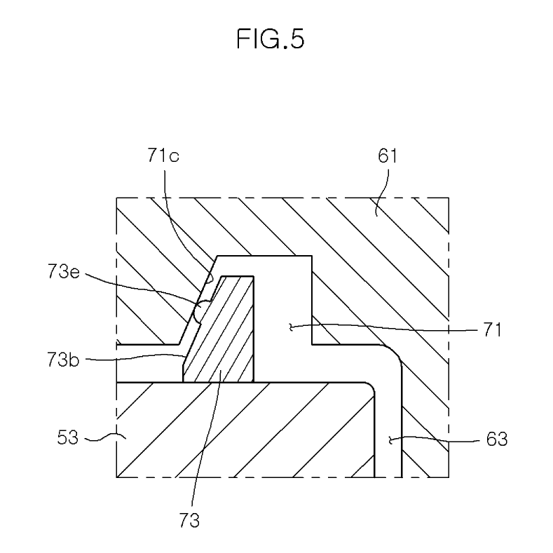

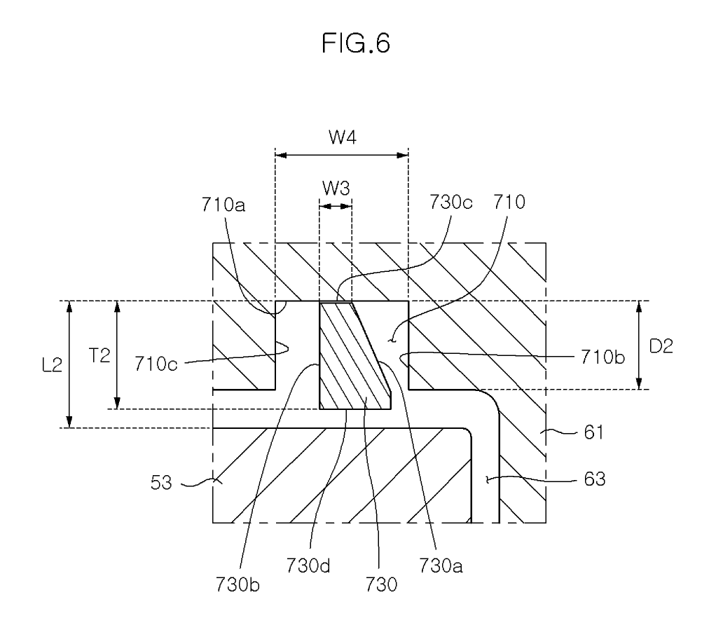

FIG. 5 shows a configuration when a circular protrusion 73e is integrally formed on inclined surface 73b of sealing member 73, where as hydraulic pressure is supplied to operational hydraulic chamber 63 to operate the clutch, circular protrusion 73e comes in contact with inclined surface 71c of sealing groove 71. One will appreciate that the circular protrusion may be monolithically formed with the inclined surface of the sealing member.

When circular protrusion 73e is in contact with inclined surface 71c of sealing groove 71, as described above, the contact area can be reduced as compared with when inclined surfaces 71c, 73b are in surface contact, such that sealing member 73 can more smoothly move down along inclined surface 71c of sealing groove 71.

Further, according to various embodiments of the present invention, a sealing groove 710 formed in clutch piston 61 has a cross-section open to retainer 53 and has an inner side 710a opposite to retainer 53 and both sides connected with inner side 710a, where both sides are vertical surfaces 710b, 710c which are perpendicular to inner side 710a.

Further, one side opposite to operational hydraulic pressure supply hole 63 in sealing member 730 disposed in sealing groove 710 is an inclined surface 730a gradually decreasing in width toward outer circumference 730c from inner circumference 730d of sealing member 730 and the other side opposite to inclined surface 730 is a vertical surface 730b having the same shape as vertical surface 710c of sealing groove 710.

Further, with sealing member 730 disposed in sealing groove 710, the thickness T2 of sealing member 730 is larger than the depth D2 of sealing groove 710 and smaller than the gap L1 between inner side 710a of sealing groove 710 and retainer 53, such that when the clutch does not operate, that is, the operation oil is not supplied to operational hydraulic chamber 63, a gap C2 is defined between inner circumference 730d of sealing member 730 and retainer 53 and the width W3 of outer circumference 730c of sealing member 730 is smaller than the width W4 of inner side 710a of sealing groove 710.

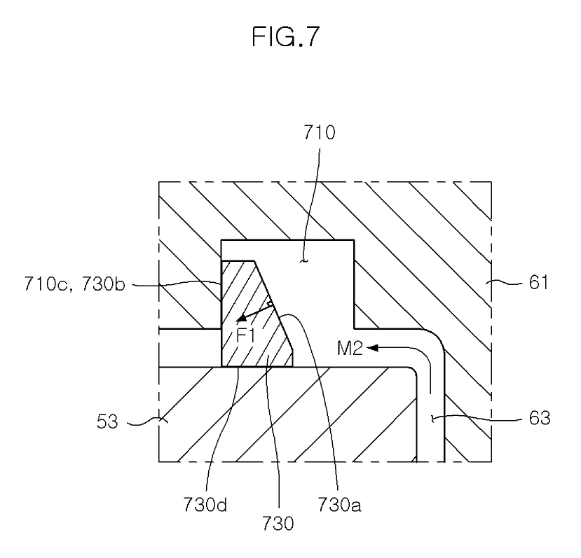

According to the structure of various embodiments, as hydraulic pressure is supplied to operational hydraulic chamber 63 (an arrow M2) when the clutch operates, as shown in FIG. 7, the pressure of the operation oil is applied to inclined surface 730a of sealing member 730. Therefore, as the pressure of the operation oil is applied perpendicularly to inclined surface 730a (an arrow F1), vertical surface 730b and inner circumference 730d of sealing member 730 consequently come in close contact with vertical side 710c of sealing groove 710 and retainer 53, such that operational hydraulic chamber 63 is kept hermetic and completely sealed by sealing member 730.

Accordingly, as clutch piston 61 is moved by the hydraulic pressure of the operation oil supplied to operational hydraulic pressure supply hole 65 and applied to clutch piston 61, plates 55 and discs 59 can transmit power by friction contact, such that the power inputted to input shaft 57 is transmitted to corresponding elements of the planetary gear set connected with hub 57 through retainer 53, plates 55, discs 59, and hub 57.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A clutch apparatus for an automatic transmission, comprising:
an operational hydraulic pressure supply hole formed in a retainer for connection with an operational hydraulic chamber formed between the retainer and a clutch piston; and
a sealing member disposed in a sealing groove formed in the clutch piston, making a gap between the retainer and the sealing member when operation oil is not supplied to the operational hydraulic chamber of a clutch, and making the sealing groove and retainer in close contact when the operation oil is supplied to the operational hydraulic chamber of the clutch such that the operational hydraulic chamber is hermetically sealed.

2. The clutch apparatus for an automatic transmission as defined in claim 1, further comprising:
a spring seat fixed to a boss portion of the retainer to be opposite to the retainer, with the clutch piston therebetwen; and
a return spring having both ends supported by the clutch piston and the spring seat and providing for pressing the clutch piston to the retainer.

3. The clutch apparatus for an automatic transmission as defined in claim 1, wherein the sealing groove has a cross-section open to the retainer, has an inner side opposite to the retainer, and two sides connected with the inner side,
one of said two sides is connected with the operational hydraulic pressure supply hole and is a vertical surface perpendicular to the inner side, and
the other of said two sides is opposite to the vertical surface and is an inclined surface making an obtuse angle with the inner side.

4. The clutch apparatus for an automatic transmission as defined in claim 3, wherein respective surfaces of the sealing member disposed in the sealing groove opposing the vertical surface and the inclined surface of the sealing groove, include a vertical surface and an inclined surface having shapes complementary to the vertical surface and the inclined surface of the sealing groove.

5. The clutch apparatus for an automatic transmission as defined in claim 4, wherein with the sealing member disposed in the sealing groove, the thickness of the sealing member is larger than the depth of the sealing groove and smaller than the gap between the inner side of the sealing groove and the retainer while the width of the outer circumference of the sealing member is smaller than the width of the inner side of the sealing groove.

6. The clutch apparatus for an automatic transmission as defined in claim 4, wherein a circular protrusion that protrudes toward the inclined surface of the sealing groove is integrally formed on the inclined surface of the sealing member.

7. The clutch apparatus for an automatic transmission as defined in claim 1, wherein the sealing groove has a cross-section open to the retainer and has an inner side opposite to the retainer and both sides connected with the inner side, and both sides are vertical surfaces which are perpendicular to the inner side.

8. The clutch apparatus for an automatic transmission as defined in claim 7, wherein one side opposite to the operational hydraulic pressure supply hole in the sealing member disposed in the sealing groove is an inclined surface gradually decreasing in width toward the outer circumference from the inner circumference of the sealing member, and the other side opposite to the inclined surface is a vertical surface having the same shape as the vertical surface of the sealing groove.

9. The clutch apparatus for an automatic transmission as defined in claim 8, wherein with the sealing member disposed in the sealing groove, the thickness of the sealing member is larger than the depth of the sealing groove and smaller than the gap between the inner side of the sealing groove and the retainer, while the width of the outer circumference of the sealing member is smaller than the width of the inner side of the sealing groove.

10. The clutch apparatus for an automatic transmission as defined in claim 2, further comprising:
an input shaft equipped with the retainer to transmit torque to the retainer;
a plurality of plates fitted on the inner circumference of the retainer;
a plurality of discs disposed between the plates; and
a hub connected with the discs to transmit power to the elements in a planetary gear set.
